(19) United States
(12) Patent Application Publication
(10) Pub. No.: US 2024/0430544 A1
(43) Pub. Date: Dec. 26, 2024

(54) METHOD FOR CLIPPING VIDEO AND ELECTRONIC DEVICE

(71) Applicant: BEIJING DAJIA INTERNET INFORMATION TECHNOLOGY CO., LTD., Beijing (CN)

(72) Inventor: Jiahui HONG, Beijing (CN)

(21) Appl. No.: 18/399,239

(22) Filed: Dec. 28, 2023

(30) Foreign Application Priority Data
Jun. 26, 2023 (CN) 202310755179.0

(51) Int. Cl. H04N 21/845; H04N 21/431

(52) U.S. Cl. CPC H04N 21/8456; H04N 21/4312

(57) ABSTRACT

Provided is a method for clipping a video. The method is performed by an electronic device and includes: in response to an input operation on a first video in a video input interface, recognizing a clipping material in the first video; displaying a recognition result interface; and in response to a video clip operation on a second video to be clipped, displaying a third video.

### CROSS-REFERENCE TO RELATED APPLICATION

This application is based on and claims priority to Chinese Patent Application No. 202310755179.0, filed on Jun. 26, 2023, the disclosure of which is herein incorporated by reference in its entirety.

### TECHNICAL FIELD

The present disclosure relates to the field of multimedia technologies, and in particular, relates to a method for clipping a video and an electronic device.

### BACKGROUND

With the development of Internet technologies, more and more users share their clipped videos on video platforms. In order to clip a more beautiful video, users usually refer to some of their favorite videos and use the clipping materials that appear in these videos to edit their own videos, such that the resulting video has a similar visual effect.

### SUMMARY

The present disclosure provides a method for clipping a video and an electronic device. The technical solutions of the present disclosure are as follows.

According to some embodiments of the present disclosure, a method for clipping a video is provided. The method includes:
in response to an input operation on a first video in a video input interface, recognizing a clipping material in a first video, wherein the video input interface is configured to input a video to be recognized;
displaying a recognition result interface, wherein the recognition result interface displays a plurality of clipping materials recognized from the first video; and
in response to a video clip operation on a second video to be clipped, displaying a third video, wherein the third video is acquired by clipping the second video using the clipping materials.

According to some embodiments of the present disclosure, an apparatus for clipping a video is provided. The apparatus includes:
a recognizing unit, configured to in response to an input operation on a first video in a video input interface, recognize a clipping material in a first video, wherein the video input interface is configured to input a video to be recognized;
a first display unit, configured to display a recognition result interface, wherein the recognition result interface displays a plurality of clipping materials recognized from the first video; and
a second display unit, configured to, in response to a video clip operation on a second video to be clipped, display a third video, wherein the third video is acquired by clipping the second video using the clipping materials.

According to some embodiments of the present disclosure, an electronic device is provided. The electronic device includes:
one or more processors; and
a memory configured to store a program code executable by the one or more processors;
wherein the one or more processors are configured to execute the program code to perform the following processes:
in response to an input operation on a first video in a video input interface, recognizing a clipping material in a first video, wherein the video input interface is configured to input a video to be recognized;
displaying a recognition result interface, wherein the recognition result interface displays a plurality of clipping materials recognized from the first video; and
in response to a video clip operation on a second video to be clipped, displaying a third video, wherein the third video is acquired by clipping the second video using the clipping materials.

According to some embodiments of the present disclosure, a non-transitory computer-readable storage medium is provided. A program code in the non-transitory computer-readable storage medium, when executed by a processor of an electronic device, causes the electronic device to perform the following processes:
in response to an input operation on a first video in a video input interface, recognizing a clipping material in a first video, wherein the video input interface is configured to input a video to be recognized;
displaying a recognition result interface, wherein the recognition result interface displays a plurality of clipping materials recognized from the first video; and
in response to a video clip operation on a second video to be clipped, displaying a third video, wherein the third video is acquired by clipping the second video using the clipping materials.

According to some embodiments of the present disclosure, a computer program product is provided, wherein the computer program product includes a computer program/instructions. When the computer program/instructions is/are executed by a processor, performing the following processes:
in response to an input operation on a first video in a video input interface, recognizing a clipping material in a first video, wherein the video input interface is configured to input a video to be recognized;
displaying a recognition result interface, wherein the recognition result interface displays a plurality of clipping materials recognized from the first video; and
in response to a video clip operation on a second video to be clipped, displaying a third video, wherein the third video is acquired by clipping the second video using the clipping materials.

### BRIEF DESCRIPTION OF THE DRAWINGS

The accompanying drawings, which are incorporated in and constitute part of the description, illustrate embodiments consistent with the present disclosure, together with the description, serve to explain the principles of the present disclosure, and do not constitute an undue limitation to the present disclosure.

FIG. 1 is a schematic diagram of an implementation environment according to some embodiments;

FIG. 2 is a flowchart of a method for clipping a video according to some embodiments;

FIG. 3 is a flowchart of another method for clipping a video according to some embodiments;

FIG. 4 is a schematic diagram of a homepage of an application according to some embodiments;

FIG. 5 is a schematic diagram of a video input interface according to some embodiments;

FIG. 6 is a schematic diagram of a loading pop-up according to some embodiments;

FIG. 7 is a schematic diagram of a recognition result interface according to some embodiments;

FIG. 8 is a schematic diagram of a video tutorial according to some embodiments;

FIG. 9 is a schematic diagram of a video clip interface according to some embodiments;

FIG. 10 is a schematic diagram of a material edit pop-up according to some embodiments;

FIG. 11 is a schematic diagram of another recognition result interface according to some embodiments;

FIG. 12 is a schematic diagram of a material recommend interface according to some embodiments;

FIG. 13 is a schematic diagram of yet another recognition result interface according to some embodiments;

FIG. 14 is a schematic diagram of still yet another recognition result interface according to some embodiments;

FIG. 15 is a schematic diagram of a video select interface according to some embodiments;

FIG. 16 is a schematic diagram of another video clip interface according to some embodiments;

FIG. 17 is a flowchart of clipping a second video according to some embodiments;

FIG. 18 is a block diagram of an apparatus for clipping a video according to some embodiments;

FIG. 19 is a block diagram of another apparatus for clipping a video according to some embodiments; and

FIG. 20 is a block diagram of an electronic device according to some embodiments.

### DETAILED DESCRIPTION

The technical solutions in the embodiments of the present disclosure are described clearly and completely with reference to the accompanying drawings to make those of ordinary skill in the art better understand the technical solutions of the present disclosure.

It is to be noted that terms “first,” “second,” and the like in the description, claims and the above accompanying drawings of the present disclosure are used for the purpose of distinguishing similar objects instead of indicating a particular order or sequence. It is understandable that data used in this way are interchangeable where appropriate, such that the embodiments of the present disclosure described herein are executable in a sequence other than those illustrated or described herein. The implementations set forth in the following description of the embodiments do not represent all implementations consistent with the disclosure. Instead, they are merely examples of apparatuses and methods consistent with aspects related to the present disclosure as recited in the appended claims.

It is noted that information (including but not limited to user device information, user personal information, and the like), data (including but not limited to data for analysis, data for storage, data for display, and the like) and signals involved in the present disclosure are information authorized by a user or fully authorized by all parties, and the collection, use and processing of relevant data comply with relevant laws, regulations and standards of relevant countries and regions. For example, a first video and a second video involved in the present disclosure are acquired with full authorization.

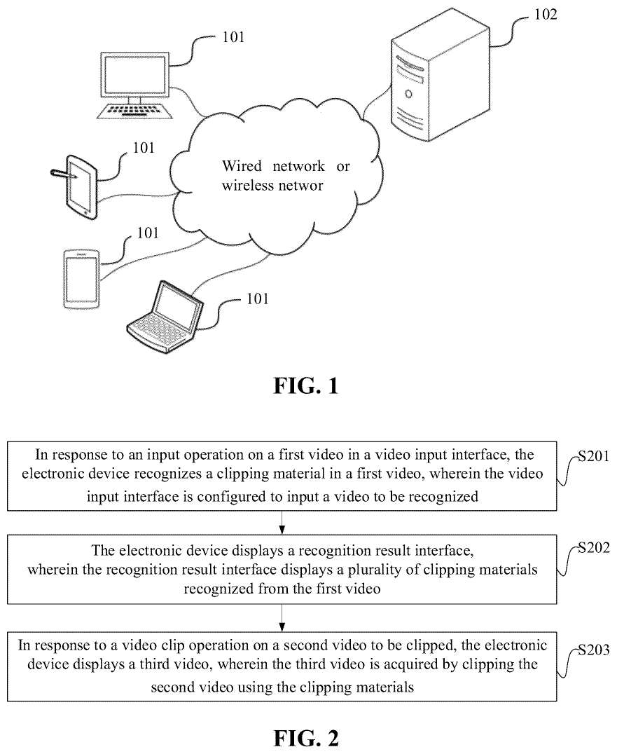

FIG. 1 is a schematic diagram of an implementation environment of a method for clipping a video according to some embodiments. Referring to FIG. 1, the implementation environment includes: a terminal 101 and a server 102.

The terminal 101 is an electronic device such as at least one of a smart phone, a smart watch, a desktop computer, a portable computer, a moving picture experts group audio layer III (MP3) player, a moving picture experts group audio layer IV (MP4) player, a laptop portable computer, and other devices. In some embodiments, the terminal 101 has an application installed and running thereon, and a user is able to log in to the application via the terminal 101 to view videos clipped by other users, or to clip his/her own video using a clipping material provided by the application. The terminal 101 is connected to the server 102 via a wireless network or a wired network. The server 102 is configured to provide a background service for the application.

In some embodiments, the terminal 101 generally refer to one of a plurality of terminals, and the present embodiment is only illustrated by the terminal 101. It is understandable by those skilled in the art that the number of the electronic devices mentioned above is more or less. For example, there are only a few terminals, or there are dozens or hundreds of terminals, or more. Neither of the number and the types of the terminals is limited in the embodiments of the present disclosure.

The server 102 is at least one of a server, a server cluster, a cloud server, a cloud computing platform, and a virtualization center. In some embodiments, there are more or less servers than those illustrated in FIG. 1, which is not limited in the embodiments of the present disclosure. In some embodiments, the server 102 further includes other functional servers to provide more comprehensive and diverse services. In some embodiments, the server 102 is responsible for primary computing work, and the terminal 101 is responsible for secondary computing work; or the server 102 is responsible for secondary computing work, and the terminal 101 is responsible for primary computing work; or the server 102 and the terminal 101 adopt a distributed computing architecture for collaborative computing. The server 102 is able to connect to the terminal 101 and other terminals via a wireless network or a wired network. In some embodiments, there are more or less servers than those shown above, which is not limited by the embodiments of the present disclosure.

In some practices, when editing a video using a clipping material from a reference video, a user typically determines a keyword for describing the clipping material by reviewing the reference video, then search a corresponding clipping material in a clipping material library/database using the keyword, and edit his/her own video using the clipping material found in the clipping material library/database such that the edited video has a visual effect similar to that of the reference video. As the above steps are all accomplished by the user himself/herself, the editing efficiency is low. Further, when there are many clipping materials in the reference video, the user need to search the clipping material one by one and then edit the video using these clipping materials, which makes the editing operations cumbersome and the editing efficiency even lower.

FIG. 2 is a flowchart of a method for clipping a video c according to some embodiments. As shown in FIG. 2, the method is performed by an electronic device such as a terminal 101 as described above and includes the following processes.

In S201, in response to an input operation on a first video in a video input interface, the electronic device recognizes a clipping material in a first video, wherein the video input interface is configured to input a video to be recognized.

In the embodiments of the present disclosure, the first video is a video to which a user refers or will use as a reference to edit his/her own video. When the user performs video clipping with reference to the first video, in order to make a resulting video have a visual effect similar to a visual effect of the first video, the user inputs the first video into the video input interface to recognize the clipping material that appear in the first video. Compared with the practice where the user recognizes the clipping material in the first video with naked eyes, determines a keyword for describing the clipping material, and searches for the clipping material in the first video by searching for the keyword, recognizing the clipping material by the electronic device improves an accuracy of recognizing the clipping material and an efficiency of recognizing the clipping material. In the subsequent process of clipping the video, the resulting video can be edited to have a visual effect similar to the visual effect of the first video by clipping the video using the clipping material recognized by the electronic device.

In response to the user successfully inputting the first video into the video input interface, the electronic device acquires the first video. The electronic device acquires the clipping material in the first video by recognizing audio and a plurality of video frames in the first video. The clipping material includes but are not limited to audio, a sticker, a special effect, a filter, a transition, text and picture-in-picture. The picture-in-picture refers to displaying a small picture in a video picture, wherein the small picture and the video picture display different video contents.

In S202, the electronic device displays a recognition result interface, wherein the recognition result interface displays a plurality of clipping materials recognized from the first video.

In the embodiments of the present disclosure, upon recognizing a plurality of clipping materials in the first video, the electronic device displays the recognition result interface and displays the aforesaid clipping materials in the recognition result interface. The user determines, by viewing the clipping materials displayed on the recognition result interface, which clipping material is required to acquire the visual effect of the first video.

In S203, in response to a video clip operation on a second video to be clipped, the electronic device displays a third video, wherein the third video is acquired by clipping the second video using the clipping materials.

In some embodiments of the present disclosure, the user applies the clipping materials recognized by the electronic device with one click on the recognition result interface. In response to the user applying the clipping materials with one click on the recognition result interface, the electronic device acquires the third video by clipping, based on the aforesaid clipping materials, the second video to be clipped. The third video has a visual effect similar to the visual effect of the first video. The electronic device displays the clipped third video for the user to view. In some embodiments, the second video to be clipped is uploaded after the user applies the clipping materials with one click, or uploaded before the user applies the clipping materials with one click. Time for the user to upload the second video is not limited in the embodiments of the present disclosure.

The embodiments of the present disclosure provide the method for clipping the video. When the user performs video clipping with reference to other videos, by recognizing the referenced video via the electronic device, the user acquires a plurality of clipping materials in the video. By applying the clipping materials with one click, the user acquires a video having a visual effect similar to a visual effect of the referenced video, wherein the video is acquired by the electronic device clipping the video to be clipped using the clipping materials. Therefore, the user can clip the video to obtain an edited video having a similar visual effect without searching for the similar clipping materials one by one in a clipping material library or manually clipping the video using the clipping materials, thereby improving the accuracy of recognizing the clipping materials and the efficiency of clipping the video.

In some embodiments, in response to the input operation on the first video in the video input interface, recognizing the clipping material in the first video includes: in response to an input operation on the first video in the video input interface, acquiring the first video; and acquiring a plurality of clipping materials in the first video and a clipping mode associated with each clipping material by recognizing the clipping material in the first video using a clipping material recognizing model, wherein the clipping material recognizing model is configured to recognize a clipping material appearing in a video and a clipping mode associated with the clipping material, the clipping mode being configured to indicate at least one of a display position of the clipping material in the video, start time and end time of the clipping material that appear in the video and a display effect of the clipping material.

In the embodiments of the present disclosure, by recognizing the first video using the clipping material recognizing model, the clipping materials in the first video and the clipping modes associated with the clipping materials are recognized accurately. In this way, compared with manual searching for the clipping materials, the efficiency and accuracy of recognizing the clipping materials are improved.

In some embodiments, prior to displaying the third video, the method further includes: acquiring the third video by clipping, in response to a video clip operation, the second video using the clipping materials based on the clipping mode associated with each of the clipping materials.

In the embodiments of the present disclosure, the third video is acquired by clipping the second video based on the clipping modes associated with the clipping materials, which not only makes clipping materials in the third video the same as the clipping materials in the first video, but also makes display positions, display effects, and start and end time of the clipping materials in the third video and in the first video the same, thereby achieving that the resulting third video has a visual effect similar to the visual effect of the first video.

In some embodiments, prior to clipping the second video using the clipping materials based on the clipping mode associated with each of the clipping materials, the method further includes: determining a duration of the first video and a duration of the second video; in a case that the duration of the second video is greater than the duration of the first video, clipping the second video to make the duration of the second video be the same as the duration of the first video by cutting the duration of the second video. In a case that the duration of the second video is less than the duration of the first video, the method includes filling the second video based on a video frame in the second video to make the duration of the second video be the same as the duration of the first video. For example, the video frames in the front portion of the second video or the last portion of the second video may be added to the second video so that the modified second video has the same duration as the duration of the first video.

In the embodiments of the present disclosure, by cutting the duration of the second video or filling the second video with addition of video frames, the duration of the second video is made to be the same as the duration of the first video. Further, the start and end time of the clipping materials in the second video are determined more accurately, such that the clipped second video has a visual effect more similar to the visual effect of the first video.

In some embodiments, the recognition result interface further displays a plurality of display areas, wherein clipping materials of a same category displayed in a same display area; and displaying the recognition result interface includes: determining a category of each of the clipping materials; and displaying each of the clipping materials in a corresponding display area based on the category of each of the clipping materials.

In some embodiments of the present disclosure, the clipping materials of the same category are aggregated in the recognition result interface by displaying the clipping materials based on their categories, such that the user is able to view the clipping materials in the first video based on their categories.

In some embodiments, the method further includes: in response to a tutorial view operation on any one of the display areas, displaying a video tutorial of the display area, wherein the video tutorial is configured to demonstrate how to clip a video using a clipping material in the display area; in response to a video clip operation in the display area, displaying a video clip interface, wherein the video clip interface displays the second video, the video tutorial, a plurality of clipping materials in the display area and a confirm control; and in response to a trigger operation on the confirm control, acquiring a fourth video by clipping the second video based on a clip operation on the second video input in the video clip interface and the clipping materials.

In some embodiments of the present disclosure, by providing a tutorial view control and the function of clipping while viewing in the display area, the user is able to view the video tutorial of the clipping materials conveniently, helping the user to quickly learn and master clipping skills and improving the clipping ability and the clipping experience of the user.

In some embodiments, the method further includes: in response to a trigger operation on any one of the clipping materials in the recognition result interface, displaying a material edit pop-up, wherein the material edit pop-up displays a delete control, a replace control and demo animation of the clipping material, the demo animation being configured to demonstrate a display effect of the clipping material; in response to a trigger operation on the delete control, removing the clipping material from the recognition result interface; in response to a trigger operation on the replace control, displaying a material recommend interface, wherein the material recommend interface displays a plurality of recommended clipping materials, the recommended clipping materials and the clipping material being of the same category; and in response to a select operation on any one of the recommended clipping materials, replacing the clipping material displayed on the recognition result interface with the recommended clipping material.

In the embodiments of the present disclosure, by providing editing functions such as deletion and replacement of the clipping materials, the user is able to adjust the clipping materials displayed on the recognition result interface based on personal preference, such that individual needs of different users are met.

In some embodiments, the recognition result interface further displays a feedback area, wherein the feedback area is configured to make feedback on a recognition result output by a clipping material recognizing model, the clipping material recognizing model being configured to recognize a clipping material in a video, the recognition result including a plurality of clipping materials recognized from the first video by using the clipping material recognizing model. The method further includes: in response to a first feedback operation in the feedback area, determining a first feedback result, wherein the first feedback result is configured to indicate that an accuracy of the recognition result is greater than an accuracy threshold; in response to a second feedback operation in the feedback area, determining a second feedback result, wherein the second feedback result is configured to indicate that the accuracy of the recognition result is not greater than the accuracy threshold; and adjusting a parameter of the clipping material recognizing model, based on the first feedback result and the second feedback result, to improve an accuracy of the recognition result output by the clipping material recognizing model.

In some embodiments of the present disclosure, the accuracy of the recognition result output by the clipping material recognizing model is determined based on the feedback result of the user. In a case that the clipping material recognizing model has low accuracy in recognizing the clipping materials, the parameter of the clipping material recognizing model is adjusted based on the accuracy of the recognition result, thereby optimizing the clipping material recognizing model and improving the accuracy in recognizing the clipping materials.

In some embodiments, in response to the video clip operation on the second video to be clipped, displaying the third video includes: in response to the video clip operation, displaying a video select interface, wherein the video select interface displays a plurality of second videos to be clipped; in response to a select operation on any one of the second videos, displaying a video clip interface, wherein the video clip interface displays the selected second video, a plurality of clipping materials displayed on the recognition result interface and a confirm control; and in response to a trigger operation on the confirm control, acquiring the third video by clipping the selected second video using the clipping materials displayed on the recognition result interface.

In some embodiments of the present disclosure, by displaying the second videos for the user to select, the user is able to quickly find the second video to be clipped. After the user selects the second video, the electronic device automatically clips the selected second video based on a plurality of clipping materials, which avoids manual clipping by the user and improves the efficiency of clipping the video.

In some embodiments, in response to the trigger operation on the confirm control, acquiring the third video by clipping the second video using the clipping materials displayed on the recognition result interface includes: in response to a trigger operation on the confirm control, acquiring a clip operation on the second video input in the video clip interface; and acquiring the third video by clipping the second video based on the clip operation and the clipping materials.

In the embodiments of the present disclosure, by providing the function of manual clipping by the user, the user is able to freely clip the second video based on his/her own preference in the process of clipping, such that the individual needs of the user are met and the clipping ability and the clipping experience of the user are improved.

In some embodiments, the video input interface displays a video upload control and a link input area, the video upload control being configured to upload a video to be recognized, the link input area being configured to input a video link of the video to be recognized; and in response to the input operation on the first video in the video input interface, recognizing the clipping material in the first video includes: in response to successfully uploading the first video by using the video upload control, recognizing the clipping material in the first video; or, in response to successfully inputting a video link of the first video in the link input area, acquiring the first video via the video link, and recognizing the clipping material in the first video.

In the embodiments of the present disclosure, by providing different video input modes on the video input interface, the user is able to select a convenient video input mode to input the referenced first video, such that the user experience and the human-computer interaction efficiency are improved.

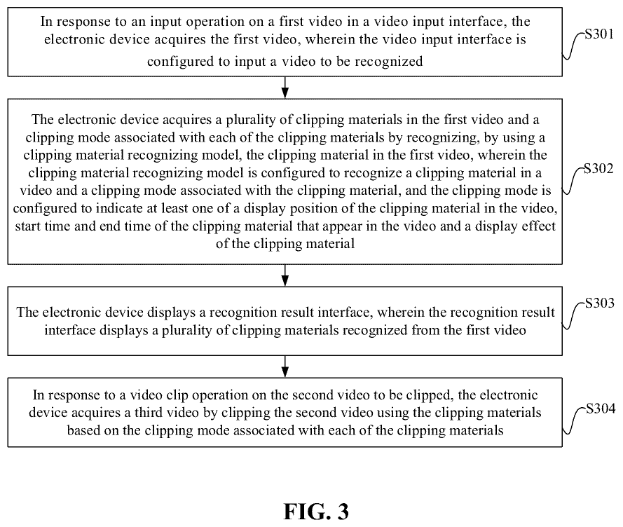

FIG. 2 shows a process of clipping a video according to the present disclosure, and the solution for clipping the video provided by the present disclosure is further described as below. FIG. 3 is a flowchart of another method for clipping a video according to some embodiments, and the method is performed by an electronic device such as a terminal 101 described in associated with FIG. 1. Referring to FIG. 3, the method includes the following processes.

In S301, in response to an input operation on a first video in a video input interface, the electronic device acquires the first video, wherein the video input interface is configured to input a video to be recognized.

In the embodiments of the present disclosure, the first video is a video that a user uses as a reference video for clipping his/her own video or a selected video. When the user performs video clipping with reference to the first video, in order to make the resulting video have a visual effect similar to a visual effect of the first video, the user inputs the first video into the video input interface so that the clipping material in the first video can be recognized by the electronic device. In the subsequent process of video clipping, clipping a user selected video using the recognized clipping material makes the resulting video have a visual effect similar to the visual effect of the first video. The video input interface is configured to input a video to be recognized of the clipping material. In response to the user successfully inputting the first video into the video input interface, the electronic device acquires the first video.

In some embodiments, a video play interface displays a video recognize portal, wherein the video recognize portal is configured to display the video input interface upon being triggered. When the user browses the video on the video play interface, in response to the user triggering the video recognize portal, the electronic device skips from a currently displayed interface to the video input interface. The user inputs the first video to be recognized into the video input interface. Alternatively, in response to the user triggering the video recognize portal on the video play interface where the first video is played, the electronic device directly acquires the first video to be recognized without displaying the video input interface. For example, when the user browses the first video on the video play interface, if the user is interested in the first video and wants to clip the video of the same style as the first video, the user triggers the video recognize portal of the video play interface. Then, in response to the user triggering the video recognize portal, the electronic device acquires the first video currently being played on the video play interface and recognizes the clipping material in the first video. The user is able to clip the video of the same style as the first video based on the clipping material recognized by the electronic device, such that the video of the same style has a visual effect similar to the visual effect of the first video.

In some embodiments, the electronic device is provided with a video clipping application, wherein the application provides functions such as a clipping material, a clipping tutorial and recognition of the clipping material in the video. For example, as shown in FIG. 4, a homepage of the video clipping application is displayed. The homepage displays a plurality of controls for video clipping, including controls “Start to clip”, “One-click output”, “Shoot”, “Clipping material”, “Video recognition” (i.e., a video recognize portal 401), and controls for clipping tutorial (e.g., “Quick clipping”, “To-the-beat tutorial” and “Color correction tutorial”). In response to a trigger operation on the video recognize portal 401 by the user, the electronic device displays a video input interface. The user inputs the first video to be recognized into the video input interface.

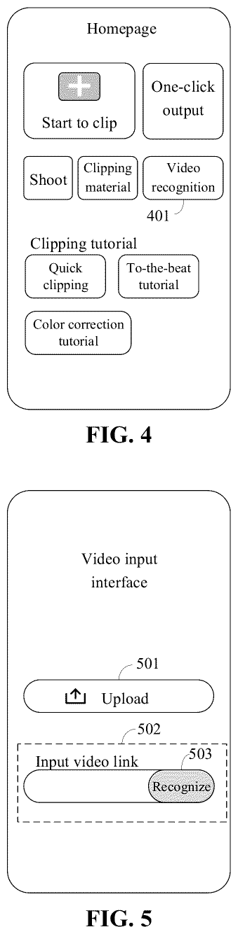

In some embodiments, the video input interface displays a video upload control and a link input area. The video upload control is configured to upload a video to be recognized. The link input area is configured to input a video link. FIG. 5 is a schematic diagram of a video input interface. As shown in FIG. 5, the user uploads the first video by triggering a video upload control 501. In response to the user successfully uploading the first video by using the video upload control 501, the electronic device can recognize the clipping material in the first video using the approaches according to the embodiments of the present disclosure. Alternatively, the user inputs a video link of the first video into the link input area 502. In response to the user successfully inputting the video link of the first video into the link input area 502, the electronic device acquires the first video via the video link and then recognizes the clipping material in the first video. Illustratively, the operation that the user successfully inputs the video link of the first video means that the user triggers a recognize control 503 in the link input area 502 upon inputting the video link of the first video into the link input area 502. In some embodiments, the electronic device displays a load pop-up as shown in FIG. 6 on the video input interface in the process of recognizing the first video. The load pop-up displays a video recognition progress 601 and a cancel control 602. The video recognition progress is configured to indicate a current progress of recognizing the first video. For example, the video recognition progress is determined by a ratio of the number of video frames recognized by the electronic device to the total number of video frames in the first video. By displaying the video recognition progress in the load pop-up, the user intuitively perceives the current progress of recognition and is able to cancel the recognition by triggering the cancel control 602 in a case that the recognition takes a long time, which avoids staying in this interface for a long time and improves the user experience. The following is an explanation of the process in which the electronic device recognizes the clipping material in the first video.

In S302, the electronic device acquires a plurality of clipping materials in the first video and a clipping mode associated with each of the clipping materials by recognizing, by using a clipping material recognizing model, the clipping material in the first video, wherein the clipping material recognizing model is configured to recognize a clipping material in a video and a clipping mode associated with the clipping material, and the clipping mode is configured to indicate at least one of a display position of the clipping material in the video, start time and end time of the clipping material that appear in the video and a display effect of the clipping material.

In the embodiments of the present disclosure, upon acquiring the first video, the electronic device acquires the clipping materials in the first video and a clipping mode associated with each of the clipping materials by recognizing, by using a clipping material recognizing model, audio and a plurality of video pictures in the first video. The clipping material recognizing model is provided in a video clipping application installed in the electronic device. The clipping material recognizing model may be any appropriate models for recognizing images, audio, and or other features related to the clipping materials. The clipping material recognizing model includes at least one of an image recognizing model and an audio recognizing model. The image recognizing model is configured to recognize an image clipping material and a text clipping material in a video picture of the first video. The audio recognizing model is configured to recognize clipping material of audio in an audio track of the first video. In some embodiments, the image recognizing model includes at least one neural network model. For example, the image recognizing model includes at least one of an object detecting model, an image segmenting model and a sequence labeling model. The object detecting model is configured to detect the image clipping material, the text clipping material, and display positions of the clipping materials in the video picture of the first video. The image clipping material includes at least one of a sticker, picture-in-picture, a filter, a special effect or the transition. The text clipping material includes at least one of text or a subtitle. The image segmenting model is configured to segment the clipping material from the video background of the video picture by performing image segmentation on the video picture, thereby acquiring the clip material. The sequence labeling model is configured to identify start time and end time of the clipping material shown in the video picture, and label the clipping material by using a time series composed of the start time and the end time. The audio recognizing model is configured to identify an audio track of the first video to identify an audio material in the audio track of the first video. The audio material includes at least one of background music and video soundtrack. Therefore, the electronic device can recognize, by using the clipping material recognizing model, various clipping materials such as the picture-in-picture, the audio, the sticker, the text, the special effect, the filter and the transition in the first video and a clipping mode associated with each of the clipping materials. By recognizing the first video via the clipping material recognizing model, the clipping materials in the first video and the clipping modes associated with the clipping materials are recognized accurately, thereby improving the efficiency and accuracy of recognizing the clipping materials.

The clipping material recognizing model may further configured to recognize a clipping mode associated with a clipping material. For example, for the clipping material of the picture-in-picture, the electronic device recognizes the time when picture-in-picture appears in the first video, that is, the start time of the picture-in-picture in the video, the display position of the picture-in-picture in the first video and the video content displayed in a small picture of the picture-in-picture. For the clipping material of the audio, the electronic device recognizes: the start time and the end time of audio appearing in the first video; the change melody of the audio, such as fade-in and fade-out; and content characteristics of the audio, such as music style and vocal characteristics of the audio. For the clipping material of the sticker, the text and the special effect, the electronic device recognizes the display position of the clipping material in the first video, the start time and the end time of its appearance in the first video, and the display effect of the clipping material, such as display form, display content, dynamic display effect and dynamic change law. For the clipping material of the filter, the electronic device recognizes the start time and the end time of the filter in the first video, the overall color tone of the filter and the illumination change law of the filter. For the clipping material of the transition, the electronic device recognizes the mode of connection between video transition clips, such as a moving direction and a moving speed of video pictures.

It is noted that in the process of recognizing any one of the clipping materials in the first video, the electronic device determines whether this clipping material exists in the clipping material library. The electronic device may be provided with a clipping material library. In some embodiments, the electronic device takes a clipping material in a clipping material library as a recognition result and output to the recognition result interface if certain condition is satisfied. In a case that recognized clipping material exists in the clipping material library, the electronic device takes this clipping material as the recognition result and output the clipping material in the clipping material library that matches the clipping material in the first video. That is, the output clipping material is the same as the recognized clipping material in this case. In a case that recognized clipping material does not exist in the clipping material library, the electronic device determines a clipping material in the clipping material library as the recognition result if a similarity of the determined clipping material to the clipping material in the first video is greater than a similarity threshold. The clipping material library includes a plurality of clipping materials. The similarity threshold is a predetermined percentage value, such as 70%, 80% or 90%, which is not limited in the embodiments of the present disclosure.

In some embodiments, for part of the clipping materials, in the case that the clipping materials do not exist in the clipping material library, the electronic device acquires the recognition result of the clipping materials by separating the clipping materials from the first video. For example, for the clipping material of the sticker, the electronic device acquires a segmented sticker image by separating the sticker from the first video by using an image segmenting model, and take the sticker image as the recognition result. For the clipping material of the audio, the electronic device separates the clipping material of the audio such as voices, accompaniments and songs in the first video by using an audio separating model, and take one or more clipping materials in a separation result as the recognition result. The audio separating model is configured to separate audio clips or audio of any one of multiple audio tracks from the audios and the videos. In some embodiments. The clipping materials separated from the first video may be stored in the clipping material library to expand the clipping material library.

In some embodiments, prior to recognizing the first video, the electronic device acquires relevant metadata and video content of the first video by analyzing the first video. The relevant metadata includes data such as a video duration, a video size and an average color of the video picture. The video content includes a scene, a figure and an object in the video picture. Further, the electronic device assists, using the related metadata and the video content, the clipping material recognizing model in recognizing the clipping material in the first video and the clipping mode associated with the clipping material to improve the accuracy in recognizing the clipping material.

In some embodiments, the electronic device not only recognizes the clipping materials in the first video, but also recommends a clipping material to the user. The electronic device acquires clipping preference information of the user by analyzing a video released by the user, a video liked by the user, a video added to favorites and a clipping material added to favorites. The clipping preference information indicates a clipping material frequently used by the user, the clipping material added to favorites by the user and a clipping method associated with the clipping material. In the process of recognizing the clipping materials in the first video by using the clipping material recognizing model, the electronic device recommends the clipping material to the user based on the clipping preference information of the user. Therefore, after the recognition is ended, the clipping materials in the first video and the clipping material recommended for the user by the electronic device are acquired. The aforesaid two kinds of clipping material are both taken as the output result of the clipping material recognizing model.

For example, in a case that the clipping preference information indicates that the user often uses a clipping material with a simple function, the electronic device recommends more basic and easy-to-use clipping materials to the user, such as filters and stickers. In a case that the clipping preference information indicates that the user often uses the clipping materials of a certain style, the electronic device recommends the clipping material of this style to the user. By recommending the clipping material to the user based on his/her clipping preference information, personalized recommendation is realized, and the clipping experience of the user is improved while the accuracy is improved.

In S303, the electronic device displays a recognition result interface, wherein the recognition result interface displays a plurality of clipping materials recognized from the first video.

In the embodiments of the present disclosure, upon acquiring a plurality of clipping materials output by the clipping material recognizing model, the electronic device displays the recognition result interface, and displays the first video and the clipping materials in the recognition result interface. The user is able to determine, by viewing the first video and the clipping materials displayed on the recognition result interface, which clipping material is required for acquiring the visual effect of the first video. For example, the electronic device marks a corresponding time point on a progress bar of the first video with the clipping material based on any one of the start time, the end time and the optimal appearance time of the clipping material in the first video. The optimal appearance time is the time at which the clipping material is completely displayed in the video picture of the first video.

In some embodiments, the recognition result interface further displays a plurality of display areas, wherein the clipping materials of the same category displayed in the same display area. Upon acquiring the clipping materials output by the clipping material recognizing model, the electronic device determines the category of each of the clipping materials. The categories of the clipping materials include picture-in-picture, audio, sticker, text, special effect, filter, transition, and the like. Each of the categories corresponds to one display area. The electronic device displays each of the clipping materials in the corresponding display area based on the category of each the clipping materials. By displaying the clipping materials based on their categories, the clipping materials of the same category are aggregated in the recognition result interface, such that the user is able to view the clipping materials in the first video based on the categories of the clipping materials.

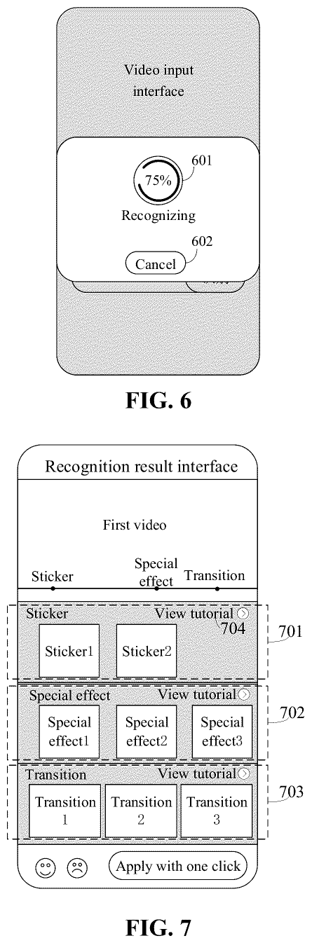

For example, FIG. 7 is a schematic diagram of a recognition result interface. As shown in FIG. 7, the recognition result interface displays a first display area 701, a second display area 702 and a third display area 703 in addition to the first video. A progress bar of the first video is marked with the time when three clipping materials of a sticker, a special effect and a transition would appear in the first video. The first display area 701 is configured to display the clipping material of the sticker; the second display area 702 is configured to display the clipping material of the special effect; and the third display area 703 is configured to display the clipping material of the transition.

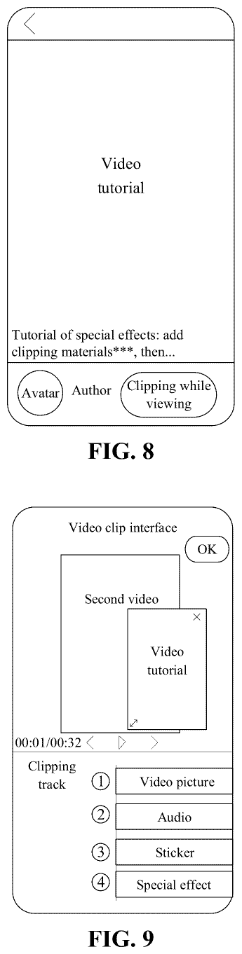

In some embodiments, the user manually clips the video while viewing a tutorial of the clipping material. As shown in FIG. 7, the display area further displays a tutorial view control 704. In response to a tutorial view operation in any one of the display areas by the user, the electronic device displays a video tutorial as shown in FIG. 8. As shown in FIG. 8, the electronic device also displays a text tutorial under the video tutorial while displaying the video tutorial. By displaying the clipping tutorial in various forms, the user is assisted in learning and mastering clipping skills quickly. The tutorial view operation triggers the tutorial view control in any one of the display areas for the user. The video tutorial is configured to demonstrate how to clip the video using the clipping material in the display area. In response to a video clip operation in the display area by the user, the electronic device displays a video clip interface. In some embodiments, the video clip operation in the display area is to trigger a clipping-while-viewing control under the video tutorial. The video clip interface displays the second video to be clipped, the video tutorial, a plurality of clipping materials in the display area and a confirm control. In response to a trigger operation on the confirm control by the user, the electronic device acquires a fourth video by clipping the second video based on a clip operation on the second video input by the user in the video clip interface and the clipping materials. The clip operation on the second video input by the user in the video clip interface is a clip operation triggered during manual clipping by the user. The fourth video is a video acquired by clipping the second video manually while viewing the tutorial. By providing the tutorial view control and the function of clipping-while-viewing in the display area, the user is assisted in viewing the video tutorial of the clipping material conveniently, which helps the user to learn and master clipping skills quickly, and improve the clipping ability and the clipping experience of the user.

For example, FIG. 9 is a schematic diagram of a video clip interface. As shown in FIG. 9, the video clip interface displays a second video and a video tutorial. By dragging the video tutorial, the user changes a display position of the video tutorial to prevent the video tutorial from obscuring the second video to be clipped. The user is able to close the video tutorial if it is unnecessary to view the video tutorial. In addition, the video clip interface further displays a plurality of clipping materials by using clipping tracks, and each of the clipping tracks corresponds to one clipping material. In the illustrated example, a clipping track 1 corresponds to a plurality of video pictures in the second video; a clipping track 2 corresponds to audio; a clipping track 3 corresponds to stickers; and a clipping track 4 corresponds to special effects. In some embodiments, the user manually clips the second video using the clipping materials on the clip track corresponding to the clipping materials while watching the second video. After the user finishes clipping, a fourth video acquired by manual clipping is produced by triggering the confirm control.

In some embodiments, the user edits the clipping materials displayed on the recognition result interface. In response to a trigger operation on any one of the clipping materials in the recognition result interface, the electronic device displays a material edit pop-up. The material edit pop-up displays a delete control, a replace control and demo animation of the clipping materials. The delete control is configured to delete the clipping material in the recognition result interface. The replace control is configured to replace the clipping material in the recognition result interface. The demo animation is configured to demonstrate a display effect of the clipping material. In response to a trigger operation on the delete control by the user, the electronic device removes the clipping material from the recognition result interface. In response to a trigger operation on the replace control by the user, the electronic device displays a material recommend interface. The material recommend interface displays a plurality of recommended clipping materials, wherein the recommended clipping materials and the clipping material are of the same category. In response to a select operation on any one of the recommended clipping materials by the user, the electronic device replaces the clipping material displayed on the recognition result interface with the recommended clipping material. By providing editing functions such as deletion and replacement of the clipping materials, the user is able to adjust the clipping materials displayed in the recognition result interface based on his/her personal preference, such that individual needs of different users are met.

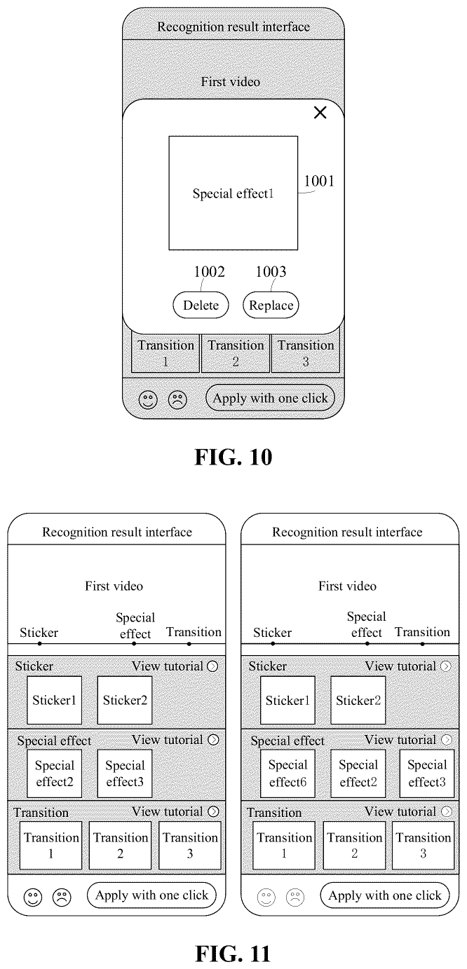

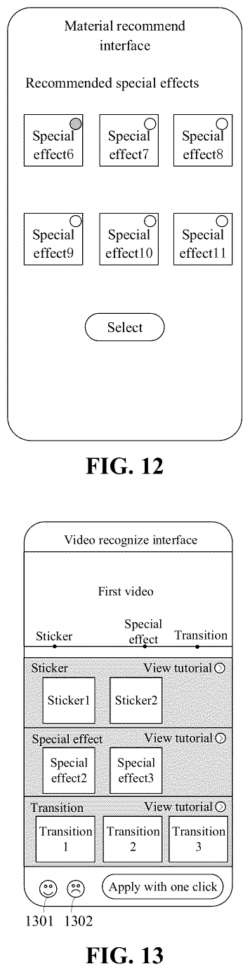

For example, in response to the trigger operation on “Special effect 1” in the recognition result interface by the user, the electronic device displays the material edit pop-up as shown in FIG. 10. The material edit pop-up displays demo animation 1001, a delete control 1002 and a replace control 1003 of the special effect 1. In the illustrated example, the demo animation 1001 is configured to demonstrate a video effect after adding special effect 1. In response to a trigger operation on the delete control 1002 by the user, the electronic device removes the clipping material (special effect 1 in this example) from the recognition result interface, and the electronic device displays the recognition result interface as shown on the left side of FIG. 11. In response to a trigger operation on the replace control 1003 by the user, the electronic device displays the material recommend interface as shown in FIG. 12. The material recommend interface displays six recommended special effects. In response to a select operation on the recommended special effect 6 by the user, the electronic device replaces the special effect 1 displayed on the recognition result interface with the special effect 6, and the electronic device displays the recognition result interface as shown on the right side of FIG. 11.

In some embodiments, the electronic device optimizes the clipping material recognizing model based on the user's feedback on the recognition result. Correspondingly, the recognition result interface further displays a feedback area, wherein the feedback area is configured to receive feedback on the recognition result output by the clipping material recognizing model. The recognition result includes the clipping materials recognized from the first video by using the clipping material recognizing model. In response to a first feedback operation in the feedback area by the user, the electronic device determines a first feedback result. The first feedback result is configured to indicate that an accuracy of the recognition result is greater than an accuracy threshold. In response to a second feedback operation in the feedback area by the user, the electronic device determines a second feedback result. The second feedback result is configured to indicate that the accuracy of the recognition result is not greater than the accuracy threshold. The accuracy threshold is a predetermined value, such as 70%, 80% or 90%, which is not limited in the embodiments of the present disclosure. The electronic device adjusts parameters of the clipping material recognizing model based on the first feedback result and the second feedback result to improve the accuracy of a recognition result output by the clipping material recognizing model. The accuracy of the recognition result output by the clipping material recognizing model is determined based on the feedback result of the user. In a case that the clipping material recognizing model has low accuracy in recognizing the clipping materials, the parameters of the clipping material recognizing model are adjusted based on the accuracy of the recognition result, thereby optimizing the clipping material recognizing model and improving the accuracy in recognizing the clipping materials.

For example, in the case the clipping material recognizing model includes the object detecting model, the electronic device displays a plurality of clipping materials detected by the object detecting model from the first video in the recognition result interface. In a case that the object detecting model detects a large number of incorrectly clipping materials, the user can perform the second feedback operation in the feedback area to feedback that he/she is not satisfied with the current recognition results. Alternatively, in a case that the object detecting model correctly detects most of the clipping materials, the user can perform the first feedback operation in the feedback area to feedback that he/she is satisfied with the current recognition results. Then, in response to the first feedback operation, the electronic device adjusts the parameter of the object detecting model based on a plurality of video pictures of the first video and a plurality of correct clipping materials identified from the first video. In this way, an ability to detect the clipping material of the object detecting model can be improved, that is, the object detecting model can learn how to detect the correct clipping material, thereby improving the accuracy of the clip material detected by the object detecting model. In some embodiments, in response to the second feedback operation, the electronic device adjusts the parameter of the object detecting model based on the video pictures of the first video and a plurality of incorrect clipping materials identified from the first video. In this way, the ability to detect the clipping material of the object detecting model can be improved, that is, the object detecting model can learn how to avoid detecting the incorrect clip material, thereby improving the accuracy of the clip material detected by the object detecting model.

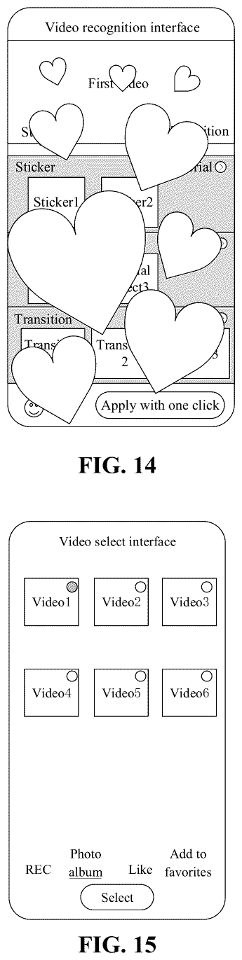

For example, in the recognition result interface shown in FIG. 13, a first feedback control 1301 and a second feedback control 1302 are displayed in the feedback area. In some embodiments, the first feedback operation is to trigger the first feedback control, and the second feedback operation is to trigger the second feedback control. In response to the user's trigger operation on the first feedback control, the electronic device further display a dynamic effect of the first feedback control in the recognition result interface as shown in FIG. 14. In the example illustrated in FIG. 14, hearts with different sizes appears on the screen, which represent the satisfaction of the user to the clipping materials.

It should be noted that the embodiments described above are explained by taking the example that the electronic device determines the feedback result of the recognition result based on the feedback operation of the user. In some embodiments, the electronic device determines the feedback result of a certain clipping material based on other behaviors of the user. For example, in a case that the user does not delete or replace the clipping materials, the electronic device determines the first feedback result of the clipping materials, wherein the first feedback result is configured to indicate that the accuracy of the electronic device in recognizing the clipping materials is greater than the accuracy threshold. In a case that the user deletes or replaces any one of the clipping materials, the electronic device determines the second feedback result of the clipping materials, wherein the second feedback result is configured to indicate that the accuracy of the electronic device in recognizing the clipping materials is not greater than the accuracy threshold.

In S304, the electronic device acquires a third video by clipping, in response to a video clip operation on the second video to be clipped, the second video using the clipping materials based on the clipping mode associated with each of the clipping materials.

In the embodiments of the present disclosure, the recognition result interface displays a video generate control, wherein the video generate control is configured to trigger a video clipping process. The video clip operation is a trigger operation on the video generate control. The video clip operation on the second video is to select the second video to be clipped upon triggering the video generate control. Therefore, in response to the user triggering the video generate control and successfully selecting the second video to be clipped, the electronic device acquires the second video. The electronic device acquires the third video by clipping the second video based on the clipping materials displayed on the recognition result interface and the clipping mode associated with each of the clipping materials. The visual effect of the third video is similar to the visual effect of the first video. The electronic device displays the clipped third video for the user to view. The third video is acquired by clipping the second video based on the clipping modes associated with the clipping materials, which not only makes the clipping materials in the third video the same as the clipping materials in the first video, but also makes the clipping modes of the clipping materials in the video the same, such as the display position, the display effect and the start and end time, such that the visual effect of the resulting third video is similar to that of the first video.

For example, for the clipping material of the audio in the first video, the electronic device recognizes that the clipping mode associated with the clipping material is the start and end time at which the audio appears in the first video. In the process of clipping the second video, the electronic device sets the start and end time of the audio appearing in the second video as start and end time of the audio appearing in the first video, thereby imitating the clipping mode of the first video. For the clipping material of the sticker in the first video, the electronic device recognizes that the clipping mode associated with the clipping material is the display position of the sticker in the first video. In the process of clipping the second video, the electronic device displays the sticker at the same display position in the second video to achieve similar visual effects.

In some embodiments, prior to clipping the second video, the electronic device cuts the duration of the second video. The electronic device determines the duration of the first video and the duration of the second video. The electronic device cuts the second video in a case that the duration of the second video is greater than the duration of the first video, such that the duration of the second video is the same as the duration of the first video. The electronic device fills the second video based on a video frame in the second video in a case that the duration of the second video is less than the duration of the first video, such that the duration of the second video is the same as the duration of the first video. By cutting the duration of the second video, the duration of the second video and the first video are made the same. Further, the start and end time of the clipping materials in the second video are determined more accurately, such that the visual effect of the clipped second video is more similar to the visual effect of the first video.

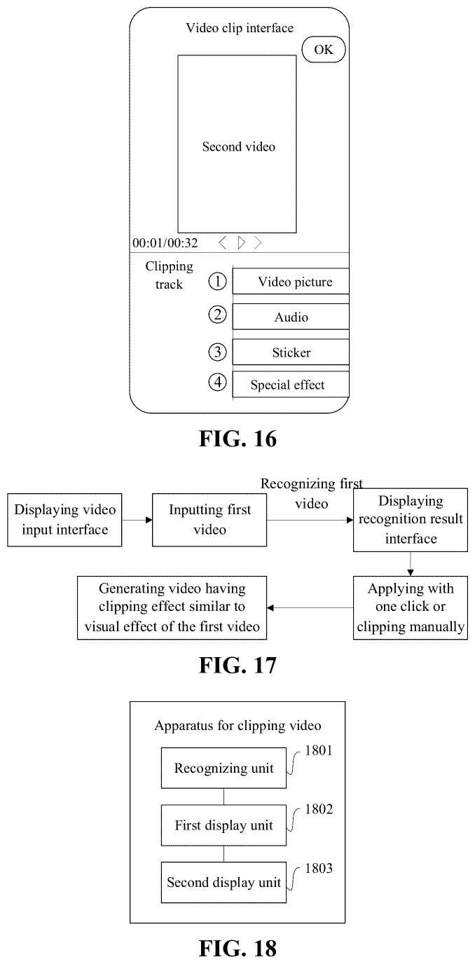

In some embodiments, the user selects the second video to be clipped. For example, in response to a video clip operation, the electronic device displays a video select interface. The video clip operation is to trigger the video generate control in the recognition result interface. As shown in FIG. 13, a one-click apply control is the video generate control. In response to the user's trigger operation on the one-click apply control in the recognition result interface, the electronic device displays the video select interface as shown in FIG. 15. The video select interface displays a plurality of selectable second videos, such as a second video stored in a local gallery of the electronic device, a second video liked by a current login account or a second video added to favorites by the current login account. In some embodiments, a selectable second video is generated by recording in response to the user triggering a record button. In response to a select operation on any one of the second videos, the electronic device displays a video clip interface as shown in FIG. 16. The video clip interface displays the second video, the clipping materials displayed in the recognition result interface, and a confirm control (“OK” button in the illustrated example). In response to the trigger operation on the confirm control, the electronic device acquires the third video by clipping the second video using the clipping materials displayed on the recognition result interface and the clipping mode associated with each of the clipping materials. By displaying a plurality of second videos for the user to select, the user is able to quickly find the second video to be clipped. After the user selects the second video, the electronic device automatically clips the second video using the clipping materials without manual clipping by the user, thereby improving the efficiency of video clipping.

In some embodiments, the user manually clips the second video using the clipping materials in the video clip interface. In response to a trigger operation on the confirm control, the electronic device acquires a clip operation on the second video input by the user in the video clip interface. The electronic device acquires the third video by clipping the second video based on the clip operation and a plurality of clipping materials. The confirm control is a control in the video clip interface that is configured to generate an edited video. The user controls the electronic device to generate the edited video by triggering the confirm control. The clip operation on the second video input by the user in the video clip interface includes the clip operation triggered in the process of manual clipping by the user, such as adding a clipping material, adjusting a display position of the clipping material on the video picture, and adjusting the start time and end time when the clipping appears in the video. The third video is a video acquired by manually clipping the second video by the user. By providing the function of manual clipping by the user, the user is able to freely clip the second video based on his/her own preference in the process of clipping, such that the individual needs of the user is met and the clipping ability and the clipping experience of the user are improved. For example, referring to FIG. 16, a plurality of clipping tracks are displayed in the video clip interface. The user can clip the second video on the clipping tracks displayed in the video clip interface. For example, the user can add background music to the second video and adjust the start and end time when the background music appears in the second video on the clipping track 2. The user can add a sticker to the video picture of the second video, adjust a position of the sticker on the video picture, and adjust the start and end time when the sticker appears in the second video on the clip track 3. In addition, the confirm control is displayed in the upper right corner of the video clip interface. Upon performing the above clipping operations, the user controls the electronic device to generate the third video by triggering the confirm control. In response to the trigger operation on the confirm control, the electronic device clips the second video based on the edit operations performed by the user on the clipping tracks to acquire the third video.

In order to more clearly explain the process of clipping the second video, the aforesaid clipping process is described below with reference to the flowchart of clipping of the second video shown in FIG. 17. As shown in FIG. 17, the electronic device first displays a video input interface. In response to the user inputting the first video into the video input interface, the electronic device acquires the first video, recognizes the first video, and acquires a plurality of clipping materials in the first video and the clipping mode associated with each of the clipping materials. Then, the electronic device displays the clipping materials and a video tutorial of the clipping materials of the same categories on the recognition result interface based on the categories of clipping materials. For the second video to be clipped selected by the user, the user applies the clipping materials with one click, and the electronic device acquires the third video by clipping the second video based on the clipping mode associated with each of the clipping materials. Or, the user acquires a fourth video by viewing the video tutorial while manually clipping the second video using the clipping materials. The third video and the fourth video have visual effects similar to the visual effect of the first video.

The embodiments of the present disclosure provide the method for clipping the video. When the user performs video clipping with reference to other videos, by recognizing the referenced video using the electronic device, the user acquires a plurality of clipping materials in the video. By applying the clipping materials with one click, the user acquires a video having a visual effect similar to the visual effect of the referenced video by clipping, using the electronic device, the video to be clipped based on the clipping materials. Therefore, the user clips the video having similar visual effect without searching for the similar clipping materials one by one in a clipping material library or manually clips the video using the clipping materials, thereby improving the accuracy of recognizing the clipping materials and the efficiency of video clipping.

All the above optional technical solutions are able to be combined in any way to form optional embodiments of the present disclosure, which will not be repeated herein.

FIG. 18 is a block diagram of an apparatus for clipping a video according to some embodiments. As shown in FIG. 18, the apparatus includes a recognizing unit 1801, a first display unit 1802 and a second display unit 1803.

The recognizing unit 1801 is configured to, in response to an input operation on a first video in a video input interface, recognize a clipping material in a first video, wherein the video input interface is configured to input a video to be recognized.

The first display unit 1802 is configured to display a recognition result interface, wherein the recognition result interface displays a plurality of clipping materials recognized from the first video.

The second display unit 1803 is configured to, in response to a video clip operation on a second video to be clipped, display a third video, wherein the third video is acquired by clipping the second video using the clipping materials.

In some embodiments, the recognizing unit 1801 is configured to, in response to an input operation on the first video in the video input interface, acquire a first video; and acquire a plurality of clipping materials in the first video and a clipping mode associated with each clipping material by recognizing the clipping material in the first video using a clipping material recognizing model, wherein the clipping material recognizing model is configured to recognize a clipping material in a video and a clipping mode associated with the clipping material, the clipping mode being configured to indicate at least one of a display position of the clipping material in the video, start time and end time of the clipping material that appear in the video and a display effect of the clipping material.

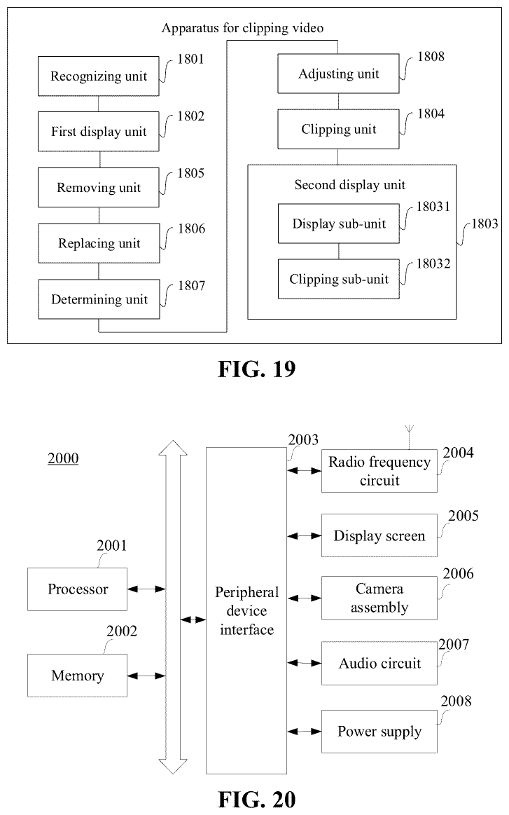

In some embodiments, FIG. 19 is a block diagram of another apparatus for clipping a video according to some embodiments. As shown in FIG. 19, the apparatus further includes a clipping unit 1804.

The clipping unit 1804 is configured to acquire the third video by clipping, in response to the video clip operation, the second video using the clipping materials based on the clipping mode associated with each of the clipping materials.

In some embodiments, the clipping unit 1804 is further configured to:
determine a duration of the first video and a duration of the second video;
in a case that the duration of the second video is greater than the duration of the first video, clip the second video to make the duration of the second video be the same as the duration of the first video; and
in a case that the duration of the second video is less than the duration of the first video, fill the second video based on a video frame in the second video to make the duration of the second video be the same as the duration of the first video.

In some embodiments, the recognition result interface further displays a plurality of display areas, wherein clipping materials of the same category displayed in the same display area; and the first display unit 1802 is configured to determine a category of each of the clipping materials; and display each of the clipping materials in a corresponding display area based on the category of each of the clipping materials.

In some embodiments, the first display unit 1802 is further configured to: in response to a tutorial view operation on any one of the display areas, display a video tutorial of the display area, wherein the video tutorial is configured to demonstrate how to clip a video using a clipping material in the display area; the first display unit 1802 is further configured to, in response to a video clip operation in the display area, display a video clip interface, wherein the video clip interface displays the second video, the video tutorial, a plurality of clipping materials in the display area and a confirm control; and the clipping unit 1804 is further configured to, in response to a trigger operation on the confirm control, acquire a fourth video by clipping the second video based on a clip operation on the second video input in the video clip interface and the clipping materials.

In some embodiments, the apparatus further includes: a removing unit 1805 and a replacing unit 1806.

The first display unit 1802 is further configured to: in response to a trigger operation on any one of the clipping materials in the recognition result interface, display a material edit pop-up, wherein the material edit pop-up displays a delete control, a replace control and demo animation of the clipping material, the demo animation being configured to demonstrate a display effect of the clipping material.

The removing unit 1805 is configured to, in response to a trigger operation on the delete control, remove the clipping material from the recognition result interface.

The first display unit 1802 is further configured to, in response to a trigger operation on the replace control, display a material recommend interface, wherein the material recommend interface displays a plurality of recommended clipping materials, the recommended clipping materials and the clipping material being of the same category.

The replacing unit 1806 is configured to, in response to a select operation on any one of the recommended clipping materials, replace the clipping material displayed on the recognition result interface with the recommended clipping material.

In some embodiments, the recognition result interface further displays a feedback area, wherein the feedback area is configured to make feedback on a recognition result output by a clipping material recognizing model, the clipping material recognizing model being configured to recognize a clipping material in a video, the recognition result including a plurality of clipping materials recognized from the first video by using the clipping material recognizing model.

The apparatus further includes: a determining unit 1807 and an adjusting unit 1808.

The determining unit 1807 is configured to, in response to a first feedback operation in the feedback area, determine a first feedback result, wherein the first feedback result is configured to indicate that an accuracy of the recognition result is greater than an accuracy threshold.

The determining unit 1807 is further configured to, in response to a second feedback operation in the feedback area, determine a second feedback result, wherein the second feedback result is configured to indicate that the accuracy of the recognition result is not greater than the accuracy threshold.

The adjusting unit 1808 is configured to adjust a parameter of the clipping material recognizing model, based on the first feedback result and the second feedback result, to improve an accuracy of the recognition result output by the clipping material recognizing model.

In some embodiments, the second display unit 1803 includes: a display sub-unit 18031 and a clipping sub-unit 18032.

The display sub-unit 18031 is configured to, in response to the video clip operation, display a video select interface, wherein the video select interface displays a plurality of optional second videos.

The display sub-unit 18031 is further configured to, in response to a select operation on any one of the second videos, display a video clip interface, wherein the video clip interface displays the second video, a plurality of clipping materials displayed on the recognition result interface and a confirm control.

The clipping sub-unit 18032 is configured to, in response to a trigger operation on the confirm control, acquire the third video by clipping the second video using the clipping materials displayed on the recognition result interface.

In some embodiments, the clipping sub-unit 18032 is configured to, in response to a trigger operation on the confirm control, acquire a clip operation on the second video input in the video clip interface; and acquire the third video by clipping the second video based on the clip operation and the clipping materials.

In some embodiments, the video input interface displays a video upload control and a link input area, the video upload control being configured to upload a video to be recognized, the link input area being configured to input a video link of the video to be recognized.

The recognizing unit 1801 is configured to, in response to successfully uploading the first video by using the video upload control, recognize the clipping material in the first video; or, in response to successfully inputting a video link of the first video in the link input area, acquire the first video via the video link, and recognizing the clipping material in the first video.

The embodiments of the present disclosure provide the apparatus for clipping the video. When the user performs video clipping with reference to other videos, by recognizing the referenced video using the electronic device, the user is able to acquire a plurality of clipping materials in the videos. By applying the clipping materials with one click, the user acquires a video having a visual effect similar to a visual effect of the referenced video by clipping, using the electronic device, the video to be clipped based on the clipping materials. Therefore, the user clips the video having similar visual effect without searching for the similar clipping materials one by one in a clipping material library or manually clips the video using the clipping materials, thereby improving the accuracy in recognizing the clipping materials and the efficiency of video clipping.

It is noted that the apparatus for clipping the video provided in the above embodiments only illustrates the division of the above-mentioned functional units during video clipping. In practice, the foregoing functions is able to be allocated to different functional units as required. That is, the internal structure of the electronic device is divided into different functional units, to complete all or some functions described above. In addition, the apparatus for clipping the video provided in the foregoing embodiments and the embodiments of the method for clipping the video belong to the same concept. A reference is made to the method embodiments for a specific implementation process of the apparatus for clipping the video, which is not repeated herein.

With regard to the apparatus for clipping the video in the aforesaid embodiments, the specific manner in which the respective modules perform the operations has been described in detail in the embodiments of the method, and will not be explained in detail herein.

FIG. 20 shows a block diagram of an electronic device provided by some embodiments. Generally, the electronic device 2000 includes a processor 2001 and a memory 2002.

The processor 2001 includes one or more processing cores, such as a 4-core processor and an 8-core processor. In some embodiments, the processor 2001 is formed by at least one hardware of a digital signal processing (DSP), a field-programmable gate array (FPGA), and a programmable logic array (PLA). In some embodiments, the processor 2001 includes a main processor and a coprocessor. The main processor is a processor for processing data in an awake state, and is also called a central processing unit (CPU). The coprocessor is a low-power-consumption processor for processing data in a standby state. In some embodiments, the processor 2001 is integrated with a graphics processing unit (GPU), which is configured to render and draw content that needs to be displayed by a display screen. In some embodiments, the processor 2001 further includes an artificial intelligence (AI) processor, wherein the AI processor is configured to process computational operations related to machine learning.

The memory 2002 includes one or more computer-readable storage mediums, wherein the computer-readable storage medium is non-transitory. In some embodiments, the memory 2002 further includes a high-speed random access memory, as well as a non-volatile memory, such as one or more disk storage devices and flash storage devices. In some embodiments, the non-transitory computer-readable storage medium in the memory 2002 is configured to store at least one instruction. The at least one instruction is configured to be executed by the processor 2001 to perform the method for clipping the video according to the method embodiments of the present disclosure.

In some embodiments, the electronic device 2000 optionally further includes a peripheral device interface 2003 and at least one peripheral device. The processor 2001, the memory 2002, and the peripheral device interface 2003 are connected by a bus or a signal line. The peripheral devices are connected to the peripheral device interface 2003 by a bus, a signal line or a circuit board. Specifically, the peripheral device includes at least one of a radio frequency circuit 2004, a display screen 2005, a camera assembly 2006, an audio circuit 2007 and a power supply 2008.

The peripheral device interface 2003 is configured to connect at least one peripheral device associated with an input/output (I/O) to the processor 2001 and the memory 2002. In some embodiments, the processor 2001, the memory 2002 and the peripheral device interface 2003 are integrated on the same chip or circuit board. In some other embodiments, any one or two of the processor 2001, the memory 2002 and the peripheral device interface 2003 are implemented on a separate chip or circuit board, which is not limited in the present embodiment.

The radio frequency circuit 2004 is configured to receive and transmit a radio frequency (RF) signal, which is also referred to as an electromagnetic signal. The radio frequency circuit 2004 communicates with a communication network and other communication devices via the electromagnetic signal. The radio frequency circuit 2004 converts the electric signal into the electromagnetic signal for transmission, or converts the received electromagnetic signal into the electric signal. In some embodiments, the radio frequency circuit 2004 includes an antenna system, an RF transceiver, one or more amplifiers, a tuner, an oscillator, a digital signal processor, a codec chipset, a subscriber identity module card, and the like. The radio frequency circuit 2004 is able to communicate with other terminals via at least one wireless communication protocol. The wireless communication protocol includes, but not limited to, the World Wide Web, a metropolitan area network, an intranet, various generations of mobile communication networks (2G, 3G, 4G, and 5G), a wireless local area network, and/or a wireless fidelity (Wi-Fi) network. In some embodiments, the RF circuit 2004 further includes a circuit related to near field communication (NFC), which is not limited in the present disclosure.

The display screen 2005 is configured to display a user interface (UI). The UI includes graphics, text, icons, videos, and any combination thereof. In a case that the display screen 2005 is a touch display screen, the display screen 2005 is able to acquire touch signals on or over the surface of the display screen 2005. In some embodiments, the touch signal is input into the processor 2001 as a control signal for processing. At this time, the display screen 2005 is further configured to provide a virtual button and/or a virtual keyboard, which are also referred to as a soft button and/or a soft keyboard. In some embodiments, one display screen 2005 is disposed on the front panel of the electronic device 2000. In some other embodiments, at least two display screens 2005 are disposed respectively on different surfaces of the electronic device 2000 or in a folded design. In further embodiments, the display screen 2005 is a flexible display screen disposed on the curved or folded surface of the electronic device 2000. In some embodiments, the display screen 2005 has an irregular shape other than a rectangle, that is, the display screen 2005 is an irregular-shaped screen. In some embodiments, the display screen 2005 is a liquid crystal display (LCD) screen or an organic light-emitting diode (OLED) display screen.

The camera assembly 2006 is configured to capture an image or a video. In some embodiments, the camera assembly 2006 includes a front camera and a rear camera. Generally, the front camera is placed on the front panel of the terminal, and the rear camera is placed on the back of the terminal. In some embodiments, at least two rear cameras are disposed, and are at least one of a main camera, a depth-of-field camera, a wide-angle camera, and a telephoto camera respectively, such that a background blurring function achieved by fusion of the main camera and the depth-of-field camera is achieved, and panoramic shooting and virtual reality (VR) shooting functions achieved by fusion of the main camera and the wide-angle camera or other fusion shooting functions are achieved. In some embodiments, the camera assembly 2006 further includes a flashlight. The flashlight is a mono-color temperature flashlight or a dual-color temperature flashlight. The dual-color temperature flash is a combination of a warm flashlight and a cold flashlight and used for light compensation at different color temperatures.

In some embodiments, the audio circuit 2007 includes a microphone and a speaker. The microphone is configured to collect sound waves of a user and environment, and convert the sound waves into electric signals which are input into the processor 2001 for processing or input into the RF circuit 2004 for voice communication. In some embodiments, for the purpose of stereo acquisition or noise reduction, there are a plurality of microphones respectively disposed at different locations of the electronic device 2000. In some embodiments, the microphone is an array microphone or an omnidirectional acquisition microphone. The speaker is configured to convert the electric signals from the processor 2001 or the radio frequency circuit 2004 into the sound waves. The speaker is a conventional film speaker or a piezoelectric ceramic speaker. In a case that the speaker is the piezoelectric ceramic speaker, the electric signal is converted into human-audible sound waves or sound waves which are inaudible to humans for the purpose of ranging and the like. In some embodiments, the audio circuit 2007 further includes a headphone jack.

The power supply 2008 is configured to power up various assemblies in the electronic device 2000. The power supply 2008 is alternating current, direct current, a disposable battery, or a rechargeable battery. In a case that the power supply 2008 includes the rechargeable battery, the rechargeable battery is a wired rechargeable battery or a wireless rechargeable battery. In some embodiments, the rechargeable battery further supports the fast charging technology.

It is understood by those skilled in the art that the structure shown in FIG. 20 does not constitute a limitation to the electronic device 2000, and may include more or less components than those illustrated, or combine some components or adopt different component arrangements.

A non-transitory computer-readable storage medium is provided in some embodiments of the present disclosure. The non-transitory computer-readable storage medium includes instructions which are executed by the processor 2001 of the electronic device 2000 to perform the above method for clipping the video. In some embodiments, the non-transitory computer-readable storage medium is a read-only memory (ROM), a random access memory (RAM), a CD-ROM, a magnetic tape, a floppy disk, an optical data storage device or the like.

A computer program product is provided in some embodiments of the present disclosure. The computer program product includes a computer program, wherein the computer program, when being executed by a processor, realizes the above method for clipping the video.

Other embodiments of the present disclosure will be easily conceived by those skilled in the art upon taking the Description into consideration and practicing the disclosure herein. The present disclosure is configured to cover any variations, uses, or adaptive changes of the present disclosure. These variations, uses, or adaptive changes follow the general principles of the present disclosure and include common general knowledge or conventional technical means in the art that are not disclosed herein. The Description and the embodiments are to be regarded as examples only. The true scope and spirit of the present disclosure are subject to the appended claims.

It is understandable that the present disclosure is not limited to the exact construction that has been described above and illustrated in the accompanying drawings, and that various modifications and changes are able to be made without departing from the scope thereof. The scope of the present disclosure is only limited by the appended claims.

What is claimed is:

1. A method for video clipping, performed by an electronic device, comprising:
in response to an input operation on a first video in a video input interface, recognizing a clipping material in a first video, wherein the video input interface is configured to input a video to be recognized;
displaying a recognition result interface, wherein the recognition result interface displays a plurality of clipping materials recognized from the first video; and
in response to a video clip operation on a second video to be clipped, displaying a third video, wherein the third video is acquired by clipping the second video using the clipping materials.

2. The method according to claim 1, wherein said in response to the input operation on the first video in the video input interface, recognizing the clipping material in the first video comprises:
in response to an input operation on the first video in the video input interface, acquiring the first video; and
recognizing, by a clipping material recognizing model, a plurality of clipping materials in the first video and a clipping mode associated with each clipping material, wherein the clipping material recognizing model is configured to recognize a clipping material in a video and a clipping mode associated with the clipping material, and wherein the clipping mode is configured to indicate at least one of a display position of the clipping material in the video, start time and end time of the clipping material that appear in the video and a display effect of the clipping material.

3. The method according to claim 2, further comprising:
acquiring the third video by clipping, in response to the video clip operation, the second video using the clipping materials based on the clipping mode associated with each of the clipping materials.

4. The method according to claim 3, further comprising:
determining a duration of the first video and a duration of the second video;
in a case that the duration of the second video is greater than the duration of the first video, cutting a duration of the second video to make the duration of the second video be the same as the duration of the first video; and
in a case that the duration of the second video is less than the duration of the first video, filling the second video based on a video frame in the second video to make the duration of the second video be the same as the duration of the first video.

5. The method according to claim 1, wherein the recognition result interface is further configured to display a plurality of display areas, wherein clipping materials of a same category are displayed in a same display area; and
said displaying the recognition result interface comprises:
determining a category of each of the clipping materials; and
displaying each of the clipping materials in a corresponding display area based on the category of each of the clipping materials.

6. The method according to claim 5, further comprising:
in response to a tutorial view operation on any one of the display areas, displaying a video tutorial of the display area, wherein the video tutorial is configured to demonstrate how to clip a video using a clipping material in the display area;
in response to a video clip operation by a user in the display area, displaying a video clip interface, wherein the video clip operation in the display area is configured to trigger a clipping-while-viewing control under the video tutorial and the video clip interface displays the second video, the video tutorial, a plurality of clipping materials in the display area and a confirm control; and
in response to a trigger operation on the confirm control by the user, acquiring a fourth video by clipping the second video based on a clip operation on the second video via an input by the user in the video clip interface and the clipping materials, wherein the fourth video is a video acquired by clipping the second video manually while viewing the tutorial.

7. The method according to claim 1, further comprising:
in response to a trigger operation on any one of the clipping materials in the recognition result interface, displaying a material edit pop-up, wherein the material edit pop-up displays a delete control, a replace control and demo animation of the clipping material, the demo animation being configured to demonstrate a display effect of the clipping material;
in response to a trigger operation on the delete control, removing the clipping material from the recognition result interface;
in response to a trigger operation on the replace control, displaying a material recommend interface, wherein the material recommend interface displays a plurality of recommended clipping materials, the recommended clipping materials and the clipping material being of a same category; and
in response to a select operation on any one of the recommended clipping materials, replacing the clipping material displayed on the recognition result interface with the recommended clipping material.

8. The method according to claim 2, wherein the recognition result interface further displays a feedback area, wherein the feedback area is configured to make feedback on a recognition result output by the clipping material recognizing model; and
the method further comprises:
in response to a first feedback operation in the feedback area, determining a first feedback result, wherein the first feedback result is configured to indicate that an accuracy of the recognition result is greater than an accuracy threshold;
in response to a second feedback operation in the feedback area, determining a second feedback result, wherein the second feedback result is configured to indicate that the accuracy of the recognition result is not greater than the accuracy threshold; and
adjusting a parameter of the clipping material recognizing model, based on the first feedback result and the second feedback result, to improve an accuracy of the recognition result output by the clipping material recognizing model.

9. The method according to claim 1, wherein said in response to the video clip operation on the second video to be clipped, displaying the third video comprises:
in response to the video clip operation, displaying a video select interface, wherein the video select interface displays a plurality of second videos to be selected;
in response to a select operation on any one of the second videos, displaying a video clip interface, wherein the video clip interface displays the selected second video, a plurality of clipping materials displayed on the recognition result interface and a confirm control; and
in response to a trigger operation on the confirm control, acquiring the third video by clipping the second video using the clipping materials displayed on the recognition result interface.

10. The method according to claim 9, wherein said in response to the trigger operation on the confirm control, acquiring the third video by clipping the second video using the clipping materials displayed on the recognition result interface comprises:
in response to a trigger operation on the confirm control, acquiring a clip operation on the second video input in the video clip interface; and
acquiring the third video by clipping the second video based on the clip operation and the clipping materials.

11. The method according to claim 1, wherein the video input interface displays a video upload control and a link input area, the video upload control being configured to upload a video to be recognized, the link input area being configured to input a video link of the video to be recognized; and
said in response to the input operation on the first video in the video input interface, recognizing the clipping material in the first video comprises:
in response to successfully uploading the first video by using the video upload control, recognizing the clipping material in the first video;
or, in response to successfully inputting a video link of the first video in the link input area, acquiring the first video via the video link, and recognizing the clipping material in the first video.

12. An electronic device for video clipping, comprising:
one or more processors; and
a memory configured to store a program code executable by the one or more processors;
wherein the one or more processors are configured to execute the program code to perform the following processes:
in response to an input operation on a first video in a video input interface, recognizing a clipping material in a first video, wherein the video input interface is configured to input a video to be recognized;
displaying a recognition result interface, wherein the recognition result interface displays a plurality of clipping materials recognized from the first video; and
in response to a video clip operation on a second video to be clipped, displaying a third video, wherein the third video is acquired by clipping the second video using the clipping materials.

13. The electronic device according to claim 12, wherein the one or more processors are configured to execute the program code to perform the following processes:
in response to an input operation on the first video in the video input interface, acquiring the first video; and
recognizing, by a clipping material recognizing model, a plurality of clipping materials in the first video and a clipping mode associated with each clipping material, wherein the clipping material recognizing model is configured to recognize a clipping material in a video and a clipping mode associated with the clipping material, and wherein the clipping mode is configured to indicate at least one of a display position of the clipping material in the video, start time and end time of the clipping material that appear in the video and a display effect of the clipping material.

14. The electronic device according to claim 13, wherein the one or more processors are further configured to execute the program code to perform the following processes:
acquiring the third video by clipping, in response to the video clip operation, the second video using the clipping materials based on the clipping mode associated with each of the clipping materials.

15. The electronic device according to claim 14, wherein the one or more processors are further configured to execute the program code to perform the following processes:
determining a duration of the first video and a duration of the second video;
in a case that the duration of the second video is greater than the duration of the first video, cutting a duration of the second video to make the duration of the second video be the same as the duration of the first video; and
in a case that the duration of the second video is less than the duration of the first video, filling the second video based on a video frame in the second video to make the duration of the second video be the same as the duration of the first video.

16. The electronic device according to claim 12, wherein the recognition result interface is further configured to display a plurality of display areas, wherein clipping materials of a same category are displayed in a same display area; and
the one or more processors are configured to execute the program code to perform the following processes:
determining a category of each of the clipping materials; and
displaying each of the clipping materials in a corresponding display area based on the category of each of the clipping materials.

17. The electronic device according to claim 16, wherein the one or more processors are further configured to execute the program code to perform the following processes:
in response to a tutorial view operation on any one of the display areas, displaying a video tutorial of the display area, wherein the video tutorial is configured to demonstrate how to clip a video using a clipping material in the display area;
in response to a video clip operation by a user in the display area, displaying a video clip interface, wherein the video clip operation in the display area is configured to trigger a clipping-while-viewing control under the video tutorial and the video clip interface displays the second video, the video tutorial, a plurality of clipping materials in the display area and a confirm control; and
in response to a trigger operation on the confirm control, acquiring a fourth video by clipping the second video based on a clip operation on the second video via an input in the video clip interface and the clipping materials, wherein the fourth video is a video acquired by clipping the second video manually while viewing the tutorial.

18. The electronic device according to claim 12, wherein the one or more processors are further configured to execute the program code to perform the following processes:
in response to a trigger operation on any one of the clipping materials in the recognition result interface, displaying a material edit pop-up, wherein the material edit pop-up displays a delete control, a replace control and demo animation of the clipping material, the demo animation being configured to demonstrate a display effect of the clipping material;
in response to a trigger operation on the delete control, removing the clipping material from the recognition result interface;
in response to a trigger operation on the replace control, displaying a material recommend interface, wherein the material recommend interface displays a plurality of recommended clipping materials, the recommended clipping materials and the clipping materials being of a same category; and
in response to a select operation on any one of the recommended clipping materials, replacing the clipping material displayed on the recognition result interface with the recommended clipping material.

19. The electronic device according to claim 12, wherein the recognition result interface further displays a feedback area, wherein the feedback area is configured to make feedback on a recognition result output by a clipping material recognizing model, the clipping material recognizing model being configured to recognize a clipping material appear in a video, the recognition result comprising a plurality of clipping materials recognized from the first video by using the clipping material recognizing model; and
the one or more processors are further configured to execute the program code to perform the following processes:
in response to a first feedback operation in the feedback area, determining a first feedback result, wherein the first feedback result is configured to indicate that an accuracy of the recognition result is greater than an accuracy threshold;
in response to a second feedback operation in the feedback area, determining a second feedback result, wherein the second feedback result is configured to indicate that the accuracy of the recognition result is not greater than the accuracy threshold; and
adjusting a parameter of the clipping material recognizing model, based on the first feedback result and the second feedback result, to improve an accuracy of the recognition result output by the clipping material recognizing model.

20. A non-transitory computer-readable storage medium, wherein an instruction in the non-transitory computer-readable storage medium, when executed by a processor of an electronic device, causes the electronic device to perform the following processes:
in response to an input operation on a first video in a video input interface, recognizing a clipping material in a first video, wherein the video input interface is configured to input a video to be recognized;
displaying a recognition result interface, wherein the recognition result interface displays a plurality of clipping materials recognized from the first video; and
in response to a video clip operation on a second video to be clipped, displaying a third video, wherein the third video is acquired by clipping the second video using the clipping materials.
